(19) United States
(12) Patent Application Publication
(10) Pub. No.: US 2005/0082445 A1
(43) Pub. Date: Apr. 21, 2005

(54) Low friction bearing support and leveling assembly and method

(75) Inventor: Oliver J. Groves, Freeland, WA (US)

Correspondence Address: BAKER & HOSTETLER LLP, Washington Square, Suite 1100, 1050 Connecticut Avenue, N.W., WASHINGTON, DC, 20036, US

(73) Assignee: The Boeing Company

(21) Appl. No.: 10/443,771

(22) Filed: May 23, 2003

(51) Int. Cl. F16M 11/24

(52) U.S. Cl. 248/188.2

(57) ABSTRACT

A low friction bearing support and leveling assembly and method utilizes a platform having a surface area that supports the bearing. The assembly has adjustable leveling feet disposed about the platform, and level measurement devices disposed on the platform to facilitate leveling the surface area on which the bearing rests. The platform also has retractable or lockable wheels for moving the platform between different installation locations.

### FIELD OF THE INVENTION

The present invention relates generally to the field of supports for low friction bearings. More particularly, the present invention relates to a leveling shoe assembly and method, for incorporating a gas or liquid bearing.

### BACKGROUND OF THE INVENTION

During the manufacture and assembly of large pieces of machinery, it is often necessary to accurately position or hold a work piece in an aligned position for proper mating. This is particularly true when assembling very large scale equipment or parts, such as an airplane engine to a wing frame. For such heavy equipment it is sometimes very difficult to make adjustments in the horizontal and vertical positioning without engaging very sophisticated and often imprecise and cumbersome positioning machinery such as, for example, cranes, hydraulic lifts, or wheel castering system. Therefore, the simple procedure, for example, of moving the bolt hole of a large piece of equipment into alignment with the mating bolt hole can sometimes involve tedious, time consuming, and/or very expensive adjustment procedures.

One approach to addressing this difficulty has been the use of air bearings which use a principle of lift similar to that of a hovercraft. Air bearings utilize an inflatable “donut-shaped” air bag which creates an air pocket with a “leaking” film of air between the assembly floor and a platform above the air bearing, which platform operates to support the object being moved. The suspending force of the air flow from the air pocket eliminates the need for any direct physical contact between the floor and supported object. Since the leaking film of air acts as a fluid with a very low coefficient of friction, the frictional forces are very low and the supported object can be moved along its lateral axes with very little physical force. Accordingly, by virtue of air bearings, heavy objects can be conveniently moved over an assembly floor by hand.

The operation and requirements of air bearings are well known in the art and descriptions regarding such can be found for example, in literature associated with the products of AeroGo, Inc. of Seattle, Wash. (see www.aerogo.com) the text of which is incorporated herein in its entirety, or Air Film Corp., also of Seattle, Wash. AeroGo has also demonstrated a water bearing for moving ship structures. Therefore, alternate forms of bearings using a non-ambient gas film or liquid film are available in the industry as substitutes for an air bearing. Likewise, polytetrafluoroethylene, Teflon®, or Delrin AF, with or without a fluid interface, are commonly used in the industry as low friction bearings.

It is well known, however, that the successful operation of an air bearing such as described above benefits from a floor surface that is both level and smooth. Otherwise, the air bearing can sometimes leak in an unsymmetrical manner around the non-level area of the floor, which can cause the air bearing to tilt or fail. Unfortunately, achieving a suitably level, smooth floor can involve the smoothing and leveling of the floor surface with fillers and/or the process of terrazzo grinding, which can entail of substantial sum of money, as well as the attendant maintenance costs. The added cost of obtaining a level and smooth floor has been a deterrent to the wide-spread use of air bearings in the industry.

Accordingly, there exists a need for systems and methods for a mechanism that has the advantages of an air or low friction bearing, but does not necessarily require a perfectly level and smooth floor.

### SUMMARY OF THE INVENTION

The foregoing needs are met, to a great extent, by the present invention, wherein in one aspect an apparatus and method is provided that in some embodiments facilitates the support for movement of objects using low friction bearing assembly which is able to accommodate at least to some extent non-level floor surfaces.

In accordance with one aspect of the present invention, a leveling bearing support device is provided that has a platform with a first surface area adapted to support a low friction bearing. At least one adjustable leveler that at least partially supports the platform and is adjustable to adjust a level condition of the platform, and at least one level measurement device that measures a level condition of the platform is provided.

In accordance with another aspect of the present invention, a support system for supporting an item is provided having platform with a first surface area. At least one adjustable leveler that at least partially supports the platform and is adjustable to adjust a level condition of the platform is provided. At least one level measurement device that measures a level condition of the platform, and a low friction bearing disposed on said platform and resting on the first surface area is provided.

There has thus been outlined, rather broadly, certain embodiments of the invention in order that the detailed description herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of an exemplary embodiment of the invention.

FIG. 2 is a perspective view of the exemplary embodiment of FIG. 1 with a manifold support plate.

FIG. 3 is a perspective view of the exemplary embodiment of FIG. 2 configured with a jack assembly.

FIG. 4 is a cross-sectional view of an exemplary embodiment of the invention.

FIG. 5 is a perspective view of another exemplary embodiment of this invention with a manifold support plate and jack assembly.

FIG. 6 is a perspective view of the exemplary embodiment of FIG. 5 without the manifold support plate and jack assembly.

FIG. 7 is a cross-sectional view of a transport and leveling section of the exemplary embodiment of FIG. 6.

FIG. 8 is a perspective view of an alternative exemplary embodiment of the invention.

FIG. 9 is a perspective view of another exemplary embodiment of the invention.

FIG. 10 is a perspective view of an exemplary embodiment of the invention configured with a transport beam structure.

FIG. 11 is a perspective view of an exemplary thrust reverser and fan cowl loader.

FIG. 12 is a perspective view of an exemplary engine uplift loader.

### DETAILED DESCRIPTION

The invention provides in some embodiments apparatus and methods that facilitate the support and movement of objects using an air bearing assembly. Preferred embodiments of the invention will now be described with reference to the drawing figures, in which like reference numerals refer to like parts throughout. The following figures provide illustrations of embodiments in accordance with the present invention which demonstrate systems and methods for facilitating the movement and alignment of objects for example over non-level or unsmooth floor surfaces using air bearings with a leveling shoe assembly.

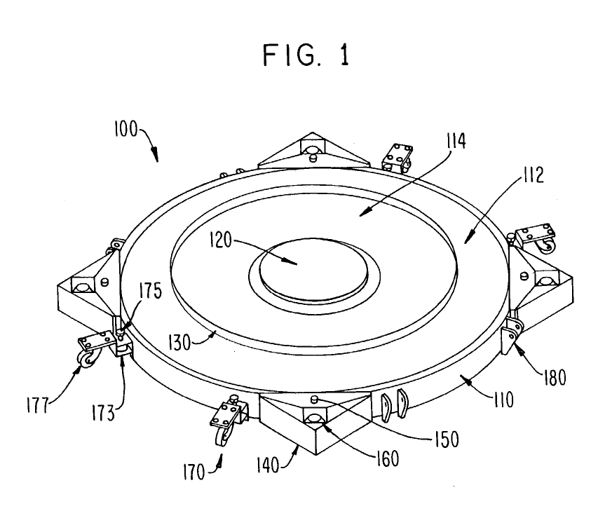

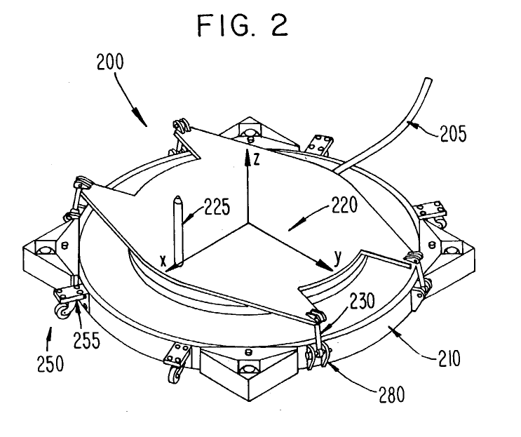

An exemplary embodiment of the present inventive low friction bearing having a leveling shoe assembly 100 is illustrated in FIG. 1. The leveling shoe assembly 100 has as its principal components a disk-like substructure 110 having a centered landing pad 120 and an outer restraining ring 130. Elastic bumpers 140, leveling feet 150 and bubble levels 160 are arranged on the perimeter of the substructure 110, and lockable load/no-load wheel assemblies 170 are placed in pairs on opposite ends of the substructure 110. Clevis pin supports 180 are attached to the sides of the substructure 110 to accommodate supporting arms, as discussed herein with reference to FIG. 2.

The substructure 110 shown in FIG. 1 is preferably machined or fabricated from a metal stock, such as 7075 anodized aluminum, in such a manner to provide an outer plateau 112 and an annular inner surface 114 that is smooth. The annular inner surface 114 is made to be smooth to facilitate the proper operation of a low friction bearing mechanism, as further discussed herein. The exemplary embodiment of FIG. 1 is crafted to provide substructure 110 width of approximately 43.5 inches and outer plateau 112 width of approximately 5 inches. Other dimensions may be used according to design requirements.

The top of the landing pad 120 is preferably but not necessarily smooth and may be integrally formed from the metal stock or may be attached to the center of the substructure 110. For example, the landing pad 120 may be attached to the substructure 110 via a welding procedure. The landing pad 120 operates as a resting surface for the low friction bearing mechanism, which may be a conventionally available air bearing. Air bearing mechanisms such as those available from AeroGo with flow rates of 40 PSI @ 22 SCFM, for example, may be placed over the landing pad 120. Other flow-rated air bearing mechanisms may be used according to design preference. Additionally, other low friction bearing mechanisms may be used, as deemed suitable, such as, non-ambient gas bearings, polytetrafluoroethylene, Delrin AF, Teflon® surfaced bearings, or liquid bearings, etc., for example.

The restraining ring 130 operates to restrict the range of lateral movement of the bearing mechanism to prevent out-of-domain operation and to protect the bearing from damage from collateral objects. Additionally, the restraining ring 130 may be of sufficient height to operate as a secondary or primary landing pad. That is, the restraining ring 130, if desired, may be fabricated to provide structural support to the bearing mechanism in addition to or, alternatively, instead of the landing pad 120. The restraining ring 130 may also be removeably attached to the substructure 110. For example, a circular channel (not shown) may be “cut” into the upper surface of the substructure 110 to enable the restraining ring 130 to be removably secured therein.

The wheel assemblies 170 are of a lockable load/no load type and are commonly available in the industry. The wheel assemblies 170 may be attached to the substructure 1 10 in any number of ways, such as, for example, by being bolted, screwed, or welded. An adjustable spring 173 is provided in the wheel assemblies 170 and moderated by an adjustable screw 175 to determine the amount of suspension afforded by the spring 173. Swivelable wheels 177 are bolted or attached to the wheel assembly 170 to provide mobility for the air bearing assembly 100. The swivelable wheels 177 may be retracted or locked upward by appropriate adjustment of the adjustable screw 175 or by sufficient downward pressure placed upon the substructure 110 such as when sufficient weight is applied.

In operation, if the leveling shoe assembly 100 is placed over a non-level floor surface, the bubble levels 160 will indicate a level condition or the degree of non-levelness. To accommodate an out-of-level condition, an operator may adjust the appropriate leveling feet 150 to adjust the assembly 100 to place an upper surface of the substructure 110 within a substantially level plane as assisted by monitoring of the bubble levels 160. Adjustment of the leveling feet 150 may occur manually, for example by rotating threadably engaged leveling feet 150. Alternatively other level indicators besides visual bubble levels 160 can be implemented such as electronic level measurement devices, and the leveling feature may be implemented automatically, for example by motor driven leveling feet controlled by a controller that receives feedback from leveling indicators. Upon proper leveling of the leveling shoe assembly 110, the operator may inflate or activate the bearing mechanism and manually maneuver an object placed onto the bearing mechanism.

It should be appreciated that the elements described in this embodiment may be modified, as desired, by one of ordinary skill in the art without departing from the spirit and scope of this invention. For example, the elastic bumpers 140 in FIG. 1 are illustrated as being triangular in shape. However, often bumpers such as those with an oval rectangular or any other desired shape may be used. Additionally, while the load/no-load wheel assemblies 170 are lockable and have an adjustable spring 173, other forms of locking and/or retractable wheels and/or suspensions may be used as are well known in the art. Furthermore, while the lockable load/no-load wheel assemblies 170 are shown as being arranged in opposing pairs, they may be arranged in any manner suitable for enabling the movement of the leveling shoe assembly 100. For example, individual lockable load/no-load wheel assemblies 170 may be arranged in a symmetric manner about the substructure 110, e.g., one on each of the three or more sides of the substructure 110.

Moreover, while the above description provides for the leveling feet 150 and the bubble levels 160 as being housed in the elastic bumper 140, other locations may be used as desired. For example, the leveling feet 150 and the bubble levels 160 may be positioned interior to the elastic bumpers 140 or, alternatively, at the median between pairs of the elastic bumpers 140.

Additionally, the landing pad 120 and restraining ring 130 are illustrated as being circular in nature. Other shapes, such as, for example, square or rectangular forms may be used. Further, the restraining ring 130 is shown as having one contiguous form, but may not necessarily be contiguous. In such case, the separate portions of the non-contiguous restraining ring 130 may be replaced or removed as desired.

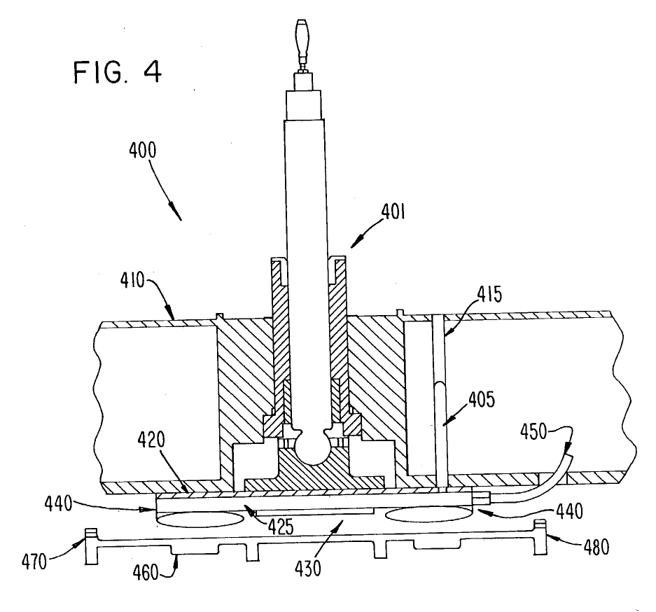

FIG. 2 is an illustration of a second embodiment 200 similar to that of FIG. 1, with a manifold support plate 220. The manifold support plate 220 is situated over the substructure 210 and a low friction bearing mechanism (not visible) is located underneath the manifold support plate 220 and above the center of the substructure 210 to provide the bearing “lifting” operation. A hose 205 supplying pressurized air or other effluent is attached to the bearing mechanism. This embodiment is especially useful when the assembly is being transported in an non-use condition between operational locations. During transportation of the low friction bearing leveling shoe assembly 200, the manifold support plate 220 is attached to the substructure 210 via the devises 280 using attachment members 230. The connection of the attachment members 230 to the manifold support plate 220 secures the manifold support plate 220 from being damaged or misplaced during movement of the air bearing leveling shoe assembly 200. Once the low friction bearing leveling shoe assembly 200 is properly situated at a desired location, the attachment members 230 are disengaged from the manifold support plate 220 or the devises 280 to enable free movement of the manifold support plate 220. However, to prevent undesirable rotation of the manifold support plate 220, a guide pin 225 is attached or affixed to the surface of the manifold support plate 220. The guide pin 225 is inserted in a guide tube (described herein with reference to FIG. 4) of the supported item to constrain the manifold support plate 220 from rotation.

The exemplary embodiment 200 of FIG. 2 illustrates load/no-load wheel assemblies 250 without the adjustable spring of FIG. 1. Cushioning of the wheel assemblies are accomplished by the placement of a neoprene or elastic pad between the upper surface and lower surfaces of the wheel assemblies 250. The wheels of the wheel assemblies 250 may be lockable between a lowered position and a raised or retracted position similar to those of FIG. 1.

The manifold support plate 220 is shown in FIG. 2 as having a smooth upper surface and is of a size that is smaller than the substructure 210. The manifold support plate 220 operates as a platform by which the bearing mechanism housed beneath it can lift whatever equipment is placed or affixed to the platform, and thus the manifold support plate 220 may be of any suitable shape or size.

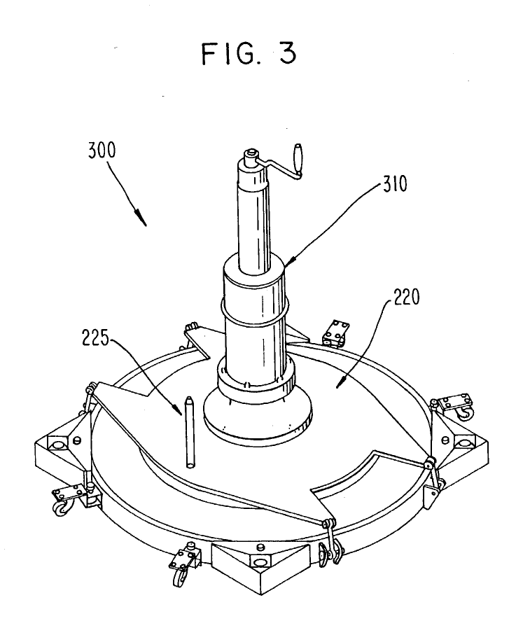

FIG. 3 is an illustration 300 of a third embodiment similar to that of FIG. 2, configured with a jack assembly 310. The jack assembly 310 is placed on top of and secured to the manifold support plate 220. By manually turning the jack assembly 310 to raise or lower its height, an operator can control the vertical height of whatever object is supported by the jack assembly 310. However, since the manifold support plate 220 is attached to the jack assembly 310, the torque generated by raising or lowering the height will cause the manifold support plate 220 to tend to rotate about its axis. To mitigate this rotation, the manifold support plate 220 is provided with the guide pin 225 which is inserted into a guide tube (described herein with reference to FIG. 4) of the supported object to restrain the manifold support plate 220 from rotation.

FIG. 4 is a partial cross-sectional view of an embodiment 400 similar the embodiment shown in FIG. 3, with an outboard leg weldment 410. The manifold support plate 420 is buoyed by a conventional bearing mechanism 430—for illustrative purposes, shown as an air bearing in this example. The conventional bearing mechanism 430 contains a manifold 425 which distributes air about the bottom portion of the bearing mechanism 430. Air is supplied via a hose 450 which is connected to an external air supply. At the outer edge of the manifold 425, restraining plates 440 are provided to constrain the bearing mechanism 430 to within the boundaries defined by the restraining ring 470 which is shown in the illustration bordering the outer edge of the shoe 460.

Drain holes 480 are provided to enable the draining of accumulated water or to assist in diffusing the air or effluent escaping from the bearing mechanism 430. The jack assembly 401 supports an outboard leg weldment 410. As the jack assembly 401 is operated to raise or lower the outboard leg weldment 410, the guide pin 405, which is illustrated as being inside a guide tube 415 of the outboard leg weldment 410, is constrained from movement. Since the guide pin 405 is attached to the manifold support plate 420, movement and rotation of the attached air hose 450 can be minimized, thus protecting the air hose 450 from damage.

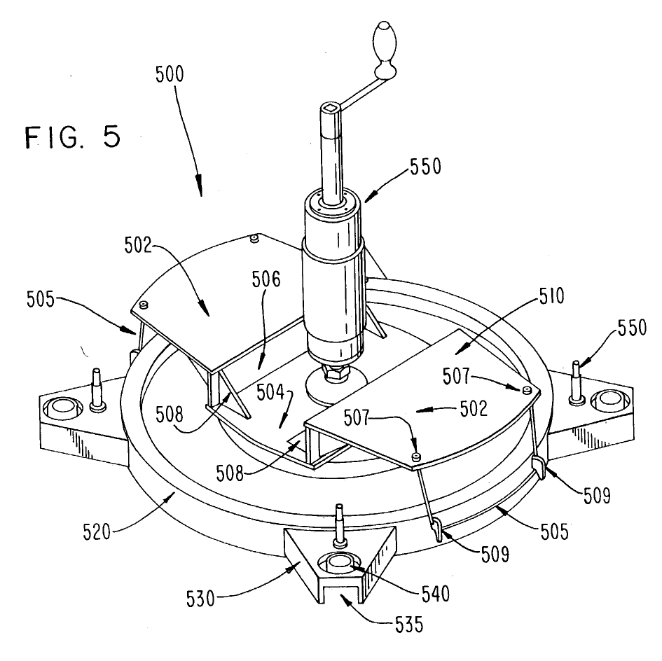

FIG. 5 is an illustration of another exemplary embodiment 500 of this invention with a manifold support plate 510 and a jack assembly 550. The manifold support plate 510 is of a different configuration that of the previous embodiments and comprises two upper faces 502 joined to a center lower face 504 via side faces 506. The side faces 506 are buttressed by braces 508. The manifold support plate 5 10 is rotationally and vertically constrained by restraining straps 505 attached at the connection points 507 on the upper faces 502. The restraining strap 505 is guided around restraining strap guides 509 which are protruding from the outer surface of the leveling shoe assembly 520. The upper faces 502 of the manifold support plate 510 are elevated above the lower face 504 to provide sufficient clearance to enable attachment of the restraining strap 505 to the manifold support plate 5 10.

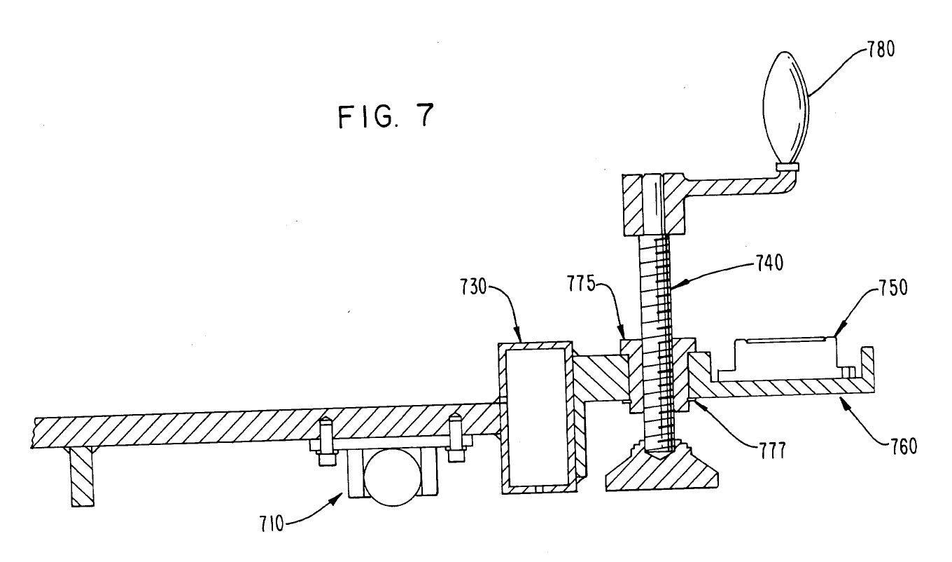

In this embodiment, the leveling shoe substructure 520 has semi-trapezoidal shaped bumpers 530 arranged in a “points-of-a-compass-like” configuration. Circular levels 540 are positioned in the bumpers 530, which are preferably made of metal or of a similarly stiff material. Leveling feet 550 are positioned interior to the bumpers 530. The outer edge of the bumpers are provided with an access channel 535 to enable easy mounting of the levels 540. An elastic barrier may be inserted into the channels 535 to provide additional cushioning. Underneath the substructure 520 are rolling ball transfers (such as shown and described herein with reference to FIG. 7) which provide substantially the same mobility function of the lockable load/no-load wheel assemblies of FIG. 1.

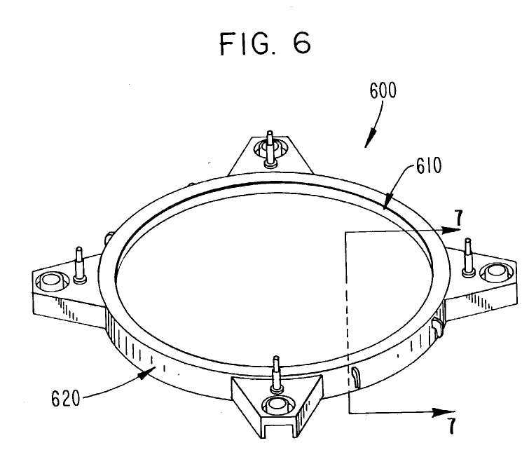

FIG. 6 is an illustration of an exemplary embodiment 600 of FIG. 5, with the manifold support plate 5 1 0 and jack assembly 550 removed. In this embodiment the leveling shoe assembly 620 is shown without an interior restraining ring or a landing pad. This exemplary embodiment utilizes the outer ridge edge 610 to act as restraining ring. Moreover, depending on the low friction bearing mechanism utilized, a landing pad is not necessary in some embodiments as demonstrated in this example. The top interior surface of the leveling shoe assembly 620 is manufactured to form a smooth and level surface for the low friction bearing mechanism.

FIG. 7 is a cross sectional view of an embodiment 700 detailing section 7-7 of FIG. 6. A ball transfer 710 is illustrated as being affixed to a periphery of the bottom surface of the leveling shoe assembly substructure 720. The ball transfer 710 is preferably a conventional ball transfer such as the MC Master Carr (CAT#5674K13) type. The circular plate 720 defining the surface that the air bearing mechanism rests on may be welded or affixed to an aluminum tube 730, having a rectangular cross-section, configured to enclose the circular plate 720. The aluminum tube 730 may be welded or otherwise integrally attached to the plate 720.

At four opposing symmetric positions on the outer periphery of the aluminum tube 730, individual leveling feet 740, levels 750 and bumpers 760 are attached. In this exemplary embodiment, the leveling feet 740 are of a Carr-Lane (No. CL-8-L) type and are positioned exterior to the aluminum tube 730. The leveling feet 740 can be raised or lowered by rotating a removable crank handle 760. The upper portion of the leveling feet 740 passes through and threadably engages an annular ring 775 in the bumper 760. The annular ring 775 is secured to the bumper 760 via external Truarc snap rings 777. Alternately, the annular ring 775 may be affixed to the bumper 760 by inserting a key between the annular ring 775 and the snap rings 777 to prevent the annular ring 775 from turning.

In close proximity to the leveling feet 740 is a level 750 of a disk or dome like shape. The exemplary embodiment utilizes an Edmund scientific circular level which is recessed into the bumper 760. The exemplary embodiment of FIG. 7 is designed with a center-to-aluminum tube 730 radius of approximately 24.5 inches. The ball transfers 710 are positioned at a radius of approximately 20.5 inches from the center and the entire leveling shoe assembly 600 is approximately 60.75 inches in diameter.

It should be very apparent that the materials, dimensions, and configuration of the various elements shown for example in the cross sectional view of FIG. 7, are by way of example only and may be altered by one of ordinary skill in the art without departing from the spirit and scope of this invention.

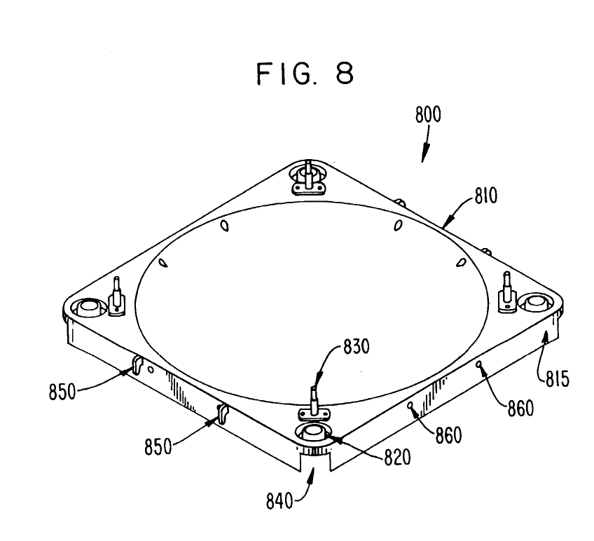

FIG. 8 illustrates an alternative embodiment 800 of a leveling shoe substructure 810. The substructure 810 of FIG. 8 may be fabricated from an aluminum stock or a substantially stiff material and is designed with corners 815. The substructure 810 is machined to accommodate the levels 820 and leveling feet 830 by integrally forming bumper portions into the corners 815 of the substructure 810. Gaps 840 are placed at the corners 815 to facilitate easy removal and/or attachment of the levels 820, as well as provide the ability to affix optional elastic bumpers, if desired. Restraining strap guides 850 are shown on opposing sides of the substructure 810. The inner top surface of the structure 810 is recessed into the substructure 810, thus forming a natural restraining barrier at the outer edge of the inner top surface. The edge of the inner top surface is cambered to permit a smooth transition, as evidenced by the tear shaped drain holes/ducts 860.

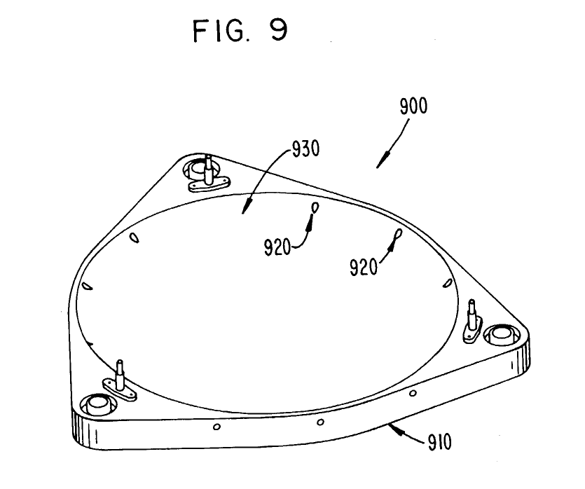

FIG. 9 illustrates an alternative embodiment 900 of a leveling shoe substructure 910. Bumper portions are formed by the corners of the substructure 910, as in FIG. 8, however, the substructure 910 is triangular in shape. Additionally, water/effluent drain holes 920 are placed around the perimeter of the substructure 910. Preferably the outer edge of the interior top surface of the substructure 910 is designed to have a camber. This camber facilitates a smoother transition for effluent from the bearing mechanism.

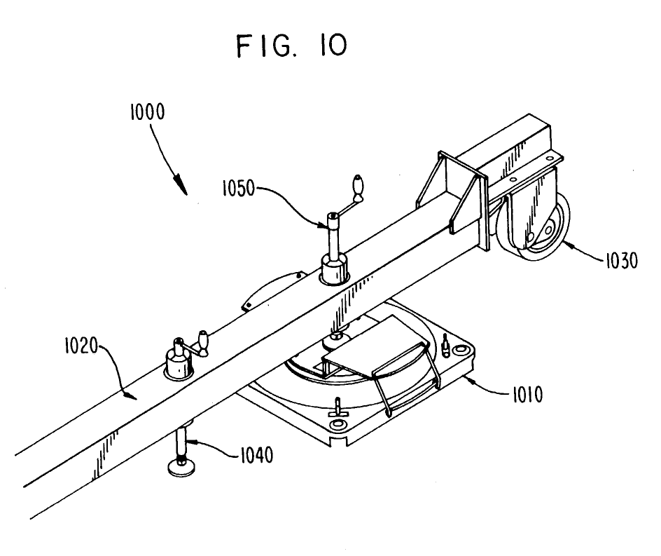

FIG. 10 illustrates an exemplary implementation 1000 of a preferred embodiment. A low friction bearing leveling shoe assembly 1010 is shown in operation with a transport beam structure 1020. The transport beam structure 1020 is shown with an auxiliary jack 1040 and a bearing jack 1050. The exemplary embodiment 1000 is movable via the transport wheel assembly 1030. When the low friction bearing assembly 1010 is not in operation, the auxiliary jack 1040 provides support for the transport beam structure 1020. When the low friction bearing assembly 1010 is in operation, the low friction bearing assembly 1010 lifts the transport beam structure 1020 and assumes the supporting responsibilities otherwise provided by the auxiliary jack 1040. In operation, the jack 1150 may be used to further raise the transport beam structure 1120, as desired.

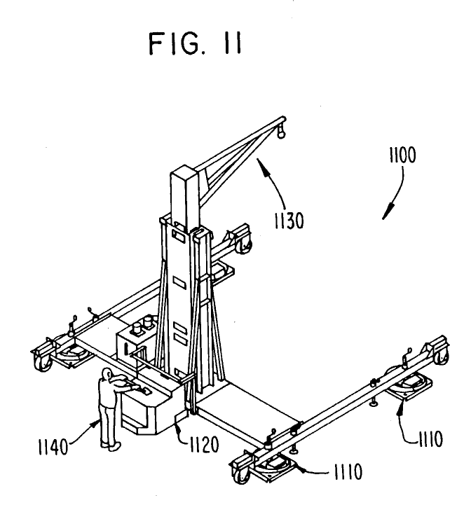

FIG. 11 is an illustration of the exemplary embodiment of FIG. 10 configured with a tug 1120 and lift crane 1 130 to provide the desired features of a thrust reverser and fan cowl loader 1100. The tug 1120, as operated by an operator 1140, provides large scale mobility of the loader 1100, while the low friction bearing leveling shoe assemblies 1100 provide the capability for finer adjustments. Details regarding the various other features relating to the tug 1 120 and the lift crane 1130 are well known in the industry and, therefore, are not further discussed herein.

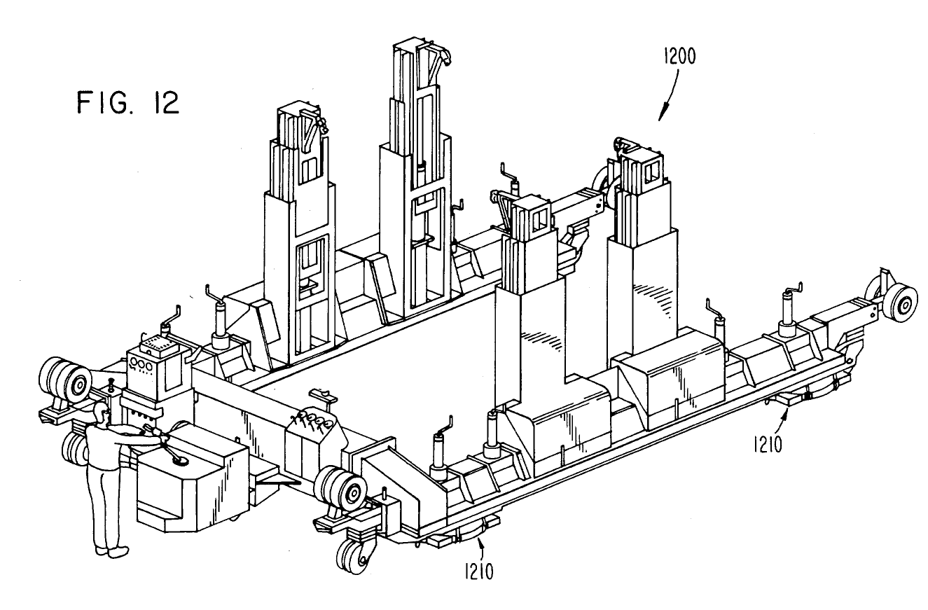

FIG. 12 is an illustration of a plurality of exemplary low friction bearing leveling shoe assemblies 1210 used in an engine uplift loader 1200. The engine uplift loader is configured with various crane and pulley mechanisms to assist in lifting an engine and are of the type well known in the aircraft industry. Similar to the features shown in FIG. 11, fine movements can be facilitated through the use of the low friction bearing shoe assemblies.

In view of the above descriptions, it should be readily apparent to one of ordinary skill that while some of the above-described embodiments illustrate the implementation of the low friction bearing leveling shoe assembly in the context of an aircraft assembly plant, other implementations and uses of this invention, not necessarily related to the aircraft industry, are suitable for various embodiments of the invention.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A leveling support apparatus, comprising:
a platform capable of supporting a low friction bearing having a first surface area;
at least one adjustable leveler that at least partially supports said platform and is adjustable to adjust a level condition of said platform; and
at least one level measurement device that measures a level condition of said platform.

2. The apparatus of claim 1, wherein the low friction bearing is at least one of an air bearing, inert gas bearing, fluid bearing, Delrin AF bearing, Teflon® bearing, and a polytetrafluoroethylene bearing.

3. The leveling support apparatus of claim 1, wherein said at least one adjustable leveler comprises at least three feet, with at least two of said at least three feet being height adjustable.

4. The leveling support apparatus of claim 1, wherein said at least one of said adjustable levelers are each threadably engaged relative to said platform.

5. The leveling support apparatus of claim 2, wherein all of said at least three feet are height adjustable.

6. The leveling support apparatus of claim 1, wherein said level measurement device comprises at least one visual level indicator.

7. The leveling support apparatus of claim 6, wherein said at least one visual level indicator comprises at least one bubble level.

8. The leveling support apparatus of claim 7, wherein said at least one bubble level is disposed on said platform.

9. The leveling support apparatus of claim 1, further comprising:
at least one protective member disposed at an outer periphery of said platform.

10. The leveling support apparatus of claim 1, further comprising:
at least one retractable roller assembly mounted to said platform and movable between a first position at which said roller assembly at least partially supports said platform, and a second position at which said roller assembly does not support said platform.

11. The leveling support apparatus of claim 10, wherein said roller assembly comprises at least one retractable caster wheel.

12. The leveling support apparatus of claim 1, wherein said first surface area of said platform comprises a landing pad having a substantially flat surface adapted to support the bearing.

13. The leveling support apparatus of claim 12, wherein said platform further comprises a restraining ring at least partially surrounding said landing pad and projecting upward relative to said landing pad.

14. The leveling air bearing support apparatus of claim 12, further comprising a manifold support plate, adapted to be mounted above said landing pad and adapted to restrain the bearing.

15. A support system for supporting an item, comprising:
a platform having a first surface area;
at least one adjustable leveler that at least partially supports said platform and is adjustable to adjust a level condition of said platform;
at least one level measurement device that measures a level condition of said platform; and
a low friction bearing disposed on said platform and resting on said first surface area.

16. The support system of claim 15, wherein the low friction bearing is at least one of an air bearing, inert gas bearing, fluid bearing, Delrin AF bearing, Teflon® bearing, and a polytetrafluoroethylene bearing.

17. A leveling support apparatus, comprising:
means for supporting a low friction bearing;
means for adjusting a level condition of said supporting means; and
measuring means for measuring a level condition of said platform.

18. The leveling support apparatus of claim 17, wherein said adjusting means comprises at least two height adjustable feet.

19. The leveling support apparatus of claim 17, further comprising:
lockable rolling means mounted to said supporting means and movable between a first position at which said rolling means at least partially supports said supporting means, and a second position at which said rolling means does not support said supporting means.

20. The leveling air bearing support apparatus of claim 17, further comprising a restraining means disposed on said supporting means for restraining lateral movement of the bearing.

21. A support system, comprising:
a low friction bearing;
means for supporting said bearing;
means for adjusting a level condition of said supporting means; and
measuring means for measuring level condition of said supporting means.

22. A method for supporting and leveling a low friction bearing, comprising:
supporting the bearing on a platform;
measuring a level condition of said platform; and
adjusting a level condition of said platform.

23. The method according to claim 22, further comprising:
engaging the bearing using at least one of an air medium, fluid medium, inert gas medium, a Delrin AF medium, polytetrafluoroethylene medium, and a Teflon® medium.
